(19) United States
(12) Patent Application Publication
(10) Pub. No.: US 2022/0117202 A1
(43) Pub. Date: Apr. 21, 2022

(54) DUAL-SIDED POULTRY FEEDERS AND WATERERS WITH VISIBILITY SHIELDS

(71) Applicant: Michael Landon De Smet, Bosque Farms, NM (US)

(72) Inventor: Michael Landon De Smet, Bosque Farms, NM (US)

(21) Appl. No.: 17/071,309

(22) Filed: Oct. 15, 2020

(51) Int. Cl. A01K 39/04

(52) U.S. Cl. CPC A01K 39/04

(57) ABSTRACT

A poultry feeder/waterer with internal shields provides space efficient poultry feeding and watering by using both sides of a tubular feeder, while preventing poultry viewing each other across the feeder using shields. The poultry feeder/waterer includes a tubular main body for holding poultry feed or water and having holes formed on either side. The centers of the holes are at the same height and are spaced apart by a distance greater than their diameter in order to provide distance between birds accessing the poultry feed or water. The poultry feeder-waterer also includes a stand for raising and leveling the tubular main body above the ground, and a pair of internal shields within the tubular main body and extending along its length prevents the birds accessing the poultry feed or water through holes on opposite sides of the tubular main body from viewing each other.

### BACKGROUND OF THE INVENTION

### 1. Field of the Invention

The present invention relates generally to livestock feeding and watering systems, and in particular, to compact dual-sided poultry feeders and waterers that provide access to the heads of poultry in a vertical plane, while preventing poultry on opposite sides of a feeder or waterer from viewing each other.

### 2. Description of the Related Art

Poultry feeders for ducks, chickens and wild fowl are in common use to provide a regulated supply of feed and to isolate the birds' access to feed so that the birds are prevented from intimidating or otherwise interfering with other birds while feeding.

Existing poultry feeders such as those disclosed in U.S. Pat. No. 1,431,472, generally provide access to feed and water simulating the birds access to feed on the ground, which have at least three drawbacks: the birds have to bend down when other birds are present and are typically facing other birds at an angle other than 90 degrees, potentially increasing the intimidation and/or fighting between birds, the amount of feed that can be introduced to the feeders is limited by the feed chamber being located on the ground, and the feed is easily scattered out of the feeder due to the location of the access points being near the ground. Feeders have disclosed, such as that described and shown in U.S. Pat. Nos. 2,267,348 and 1,610,176, that provide some elevation off of the ground and a generally side-by-side 90 degree access to feed by animals, but such feeders are limited to single-sided access, which increases the space required by the feeder for a given number of animals that the feeder can feed at one time.

Therefore, it would be desirable to provide compact poultry feeders and waterers that can maintain a supply of feed and water to a relatively large number of fowl while preventing them from viewing each other and the consequent interruption or attack.

### SUMMARY OF THE INVENTION

The above objectives, among others, are achieved in a poultry feeder/waterer and a method of use of the poultry feeding/watering system.

The poultry feeder/waterer includes a tubular main body for holding poultry feed or water. The tubular main body includes a plurality of holes formed therethrough on a first side of the tubular main body and on a second side opposite the first side. Centers of the plurality of holes are at the same height and the holes on each side of the tubular main body are spaced apart by a distance greater than their diameter to provide distance between birds accessing the poultry feed or water. The poultry feeder/waterer also includes a stand for raising and leveling the tubular main body above the ground and a pair of internal shields within the tubular main body and extending along the length thereof that prevents the birds accessing the poultry feed or water through holes on opposite sides of the tubular main body from viewing each other.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a front left perspective view of an example poultry feeder/waterer 10 according to an embodiment of the disclosure.

FIG. 2 is a left front perspective view of example poultry feeder/waterer 10.

FIG. 3 is a left end view of example poultry feeder/waterer 10.

FIG. 4 is a top view of example poultry feeder/waterer 10 in use with roof 16 removed.

FIG. 5A is an inner face view of, FIG. 5B is an edge view of, and FIG. 5C is a perspective view of, an example left end plug 22A that may be used in poultry feeder/waterer 10.

FIG. 6 is a side view of an example poultry waterer 10A showing an example internal detail.

### DESCRIPTION OF ILLUSTRATIVE EMBODIMENT

The present disclosure illustrates poultry feeding and waterers that provide compact feeding/watering area, while reducing incidences of birds interfering with each other. While the term “poultry” is used repeatedly herein in describing the example embodiment, it is understood that the disclosure applies also to feeders and waterers for other domestic fowl, such as turkeys and geese, and to wild fowl such as wild birds and ducks, with appropriate scaling for the size of the birds and their relative aggressiveness. The poultry feeders/waterers include a tube, which in the disclosed embodiment is cylindrical, but a circular cross-section is not a limitation of the disclosure. For example, the tube of a feeder/waterer in accordance with the disclosure may be of rectangular or triangular cross-section. The tube has a plurality of holes on each side, effectively doubling the number of birds that may be fed or watered for a given size of tube. Visibility shields are included that prevent birds on opposite sides of the tube from viewing each other, and in the case of feeders also retains feed above the shield, so that the tube does not fill beyond a level of the bottom of the holes.

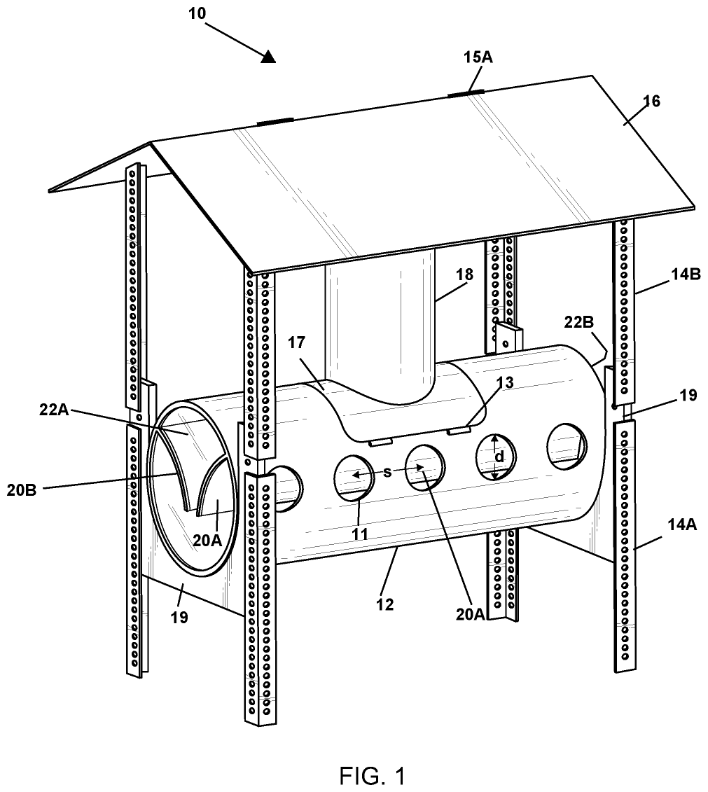

Referring now to FIG. 1, an example poultry feeder/waterer 10 in accordance with an embodiment of the disclosure is shown. A cylindrical tube 12 having a diameter that is nominally 10 inches for chickens, but that may be larger for feeding/watering larger fowl, e.g., turkeys or which may be smaller for feeders/waterers for ducks or wild birds, is supported by a pair of brackets 19 that have U-shaped cutout in which cylindrical tube 12 rests. Cylindrical tube 12 provides a main body of example poultry feeder/waterer 10 An adjustable stand is formed by four lower legs 14A that permit leveling and height adjustment of cylindrical tube 12 by attaching to brackets 19 and four upper supports 14B that secure a roof 16 above a feed hopper or water tank 18, which is mounted to cylindrical tube 12 with a saddle-shaped flange 17 that attaches to cylindrical tube 12 with tabs 13 that fit in corresponding cut-outs (not shown) in cylindrical tube 12. Cylindrical tube 12 holds poultry feed or water received from hopper or water tank 18, which is accessed by the birds through holes 11 formed through the sides of cylindrical tube 12. Holes have a diameter d, which is nominally 2 inches for chickens, but is scaled for other birds, depending on their size. The spacing s between holes is nominally 5-6 inches for chickens, but may be increased or decreased depending on both the size of the birds and their aggressiveness. Spacing s needs to be sufficient to keep adjacent birds from noticing each other or reaching the other's head within cylindrical tube 20. Birds feeding or drinking at holes on opposite sides of are prevented from distracting each other by an internal pair of shields 20A, 20B that, in the case of a feeder, retain feed above their upper surfaces so that feed from hopper 18 does not immediately fill the entire inner volume of cylindrical tube 12. Shields 20A, 20B terminate above the bottom of cylindrical tube 20 to permit feed to spread sufficiently so that the fowl can reach the feed through holes 11. A pair of transparent end caps 22A, 22B which are generally formed from an acrylic or polycarbonate material, provide closure of cylindrical tube 12 for retaining feed and water, while permitting viewing of the current level of water or feed within cylindrical tube, so that it can be quickly determined when hopper or water tank 18 is empty. End caps 22A, 22B also support shields 20A, 20B at the ends of poultry feeder/waterer via grooves cut in their interior face. In the illustrated embodiment, the symmetry shields 20A, 20B allows for the same component to be used for end caps 22A, 22B, but other designs may require end caps that differ in design from each other.

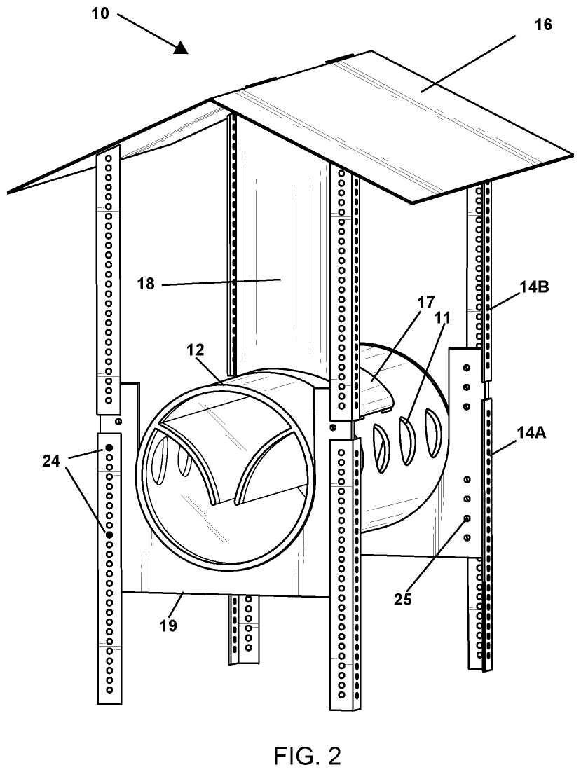

Referring now to FIG. 2, a left front perspective view of example poultry feeder/waterer 10 is shown. Adjustments are made to the height and level of cylindrical tube 12 by removing and replacing fasteners (e.g., bolts) 24 within bolt holes 25 while shifting the position of brackets 19 with respect to lower legs 14A. Similarly, the height of roof 16 may be adjusted as needed by shifting the position of brackets 19 with respect to upper supports 14B.

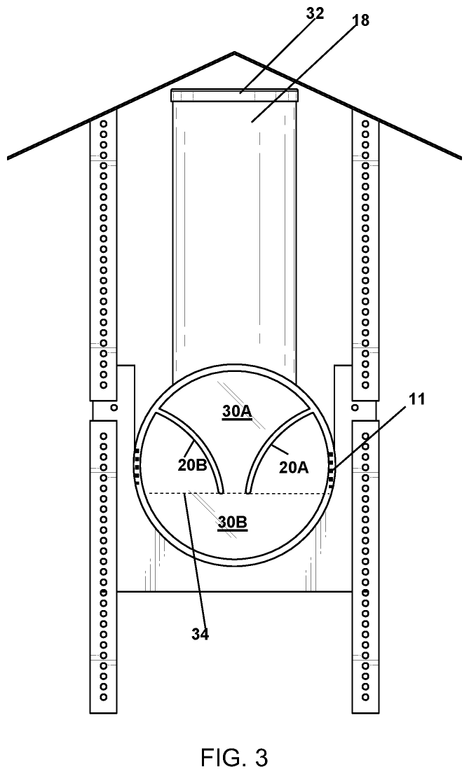

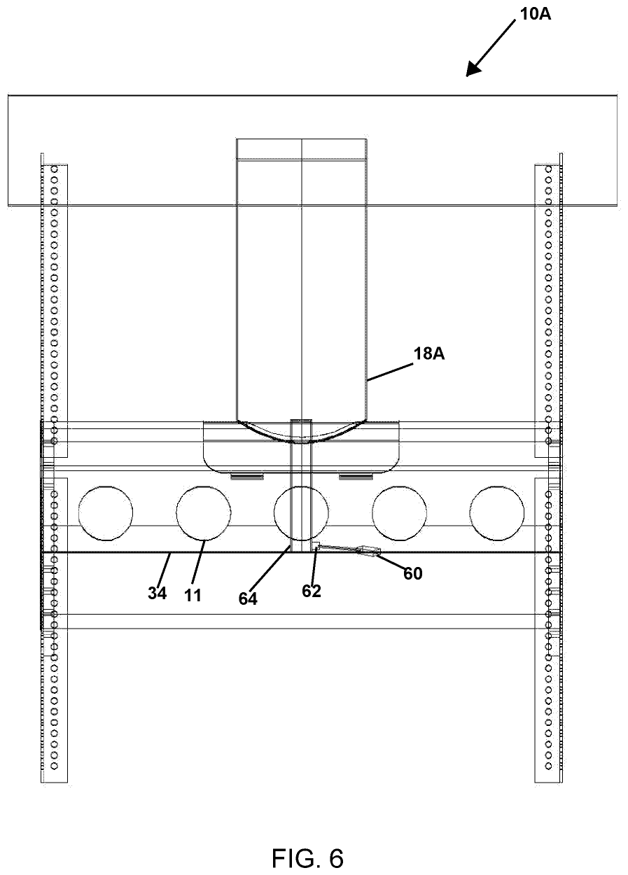

Referring now to FIG. 3, a left end view of example poultry feeder/waterer 10 is shown. When configured as a waterer, a level of water 34 is maintained below the bottom edges of holes 11 by a float valve arrangement as described below with reference to FIG. 6. When configured as a feeder, the poultry feed 11 is maintained at a level below the bottom edges of holes 11 by the constricting action of the internal volume 30A of cylindrical tube 12 above and between shields 20A and 20B, which causes resistance above the portion of feed deposited in volume 30B, so that hopper 18A does not empty to fill cylindrical tube 12 above the bottom edges of holes 11. Hopper 18A is closed via a cap 32, which may also be fitted to the top of hopper or water tank 18 in the configurations described above.

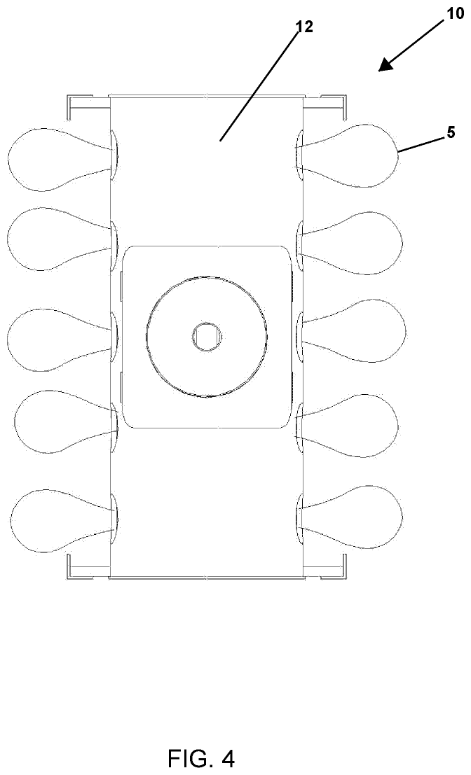

Referring now to FIG. 4, a top view of example poultry feeder/waterer 10 is shown with roof 16 removed, as in use to supply feed or water to chickens 5. While the form of the disclosed example poultry feeder/waterer 10 is one suitable for feeding ten chickens at a time, and provides compact system only two feet long, the instant disclosure is understood to encompass systems scaled for larger production use, for example, a feeder constructed with a cylindrical tube 20 feet long would simultaneously feed approximately 100 chickens. For residential use, the typical poultry volume is 5-10 chickens on average, so the depicted example poultry feeder/waterer 10 is ideally suited to that purpose.

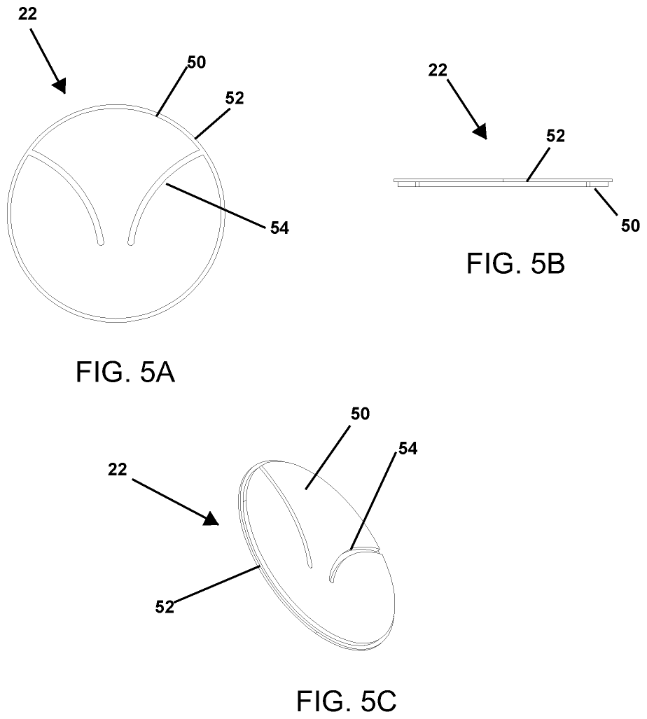

Referring now to FIGS. 5A-5C, details of an example end cap 22 that may be used as end caps 22A, 22B in example poultry feeder/waterer 10, are shown in an inner face view, an edge view of, and a perspective view, respectively. Grooves 54 are formed in the inner face portion 50 of end cap 22, which has a diameter sized to fit snugly within ends of cylindrical tube 12 and an outer portion 50 has a diameter sized to match the outer dimension of cylindrical tube 12, to conform the outer surface of cylindrical tube 12 to end caps 22A, 22B. Grooves 54 are curved and have a width to match the profile of shields 20A, 20B so that the ends of shields 20A, 20B are secured and supported by end caps 22A, 22B, as illustrated in FIGS. 1-2. End cap 22 may be made from a transparent material, such as acrylic or polycarbonate, as mentioned above.

Referring now to FIG. 6, a side view of an example poultry waterer 10A is shown with internal plumbing details revealed. A tank 18A holds water that is provided to a smaller diameter pipe 64 that extends between shields 20A, 20B and terminates in a float valve assembly comprising a valve 62 that is threaded into pipe 64 and a float 60 that is adjusted to set the level of water 34 within cylindrical tube 12 so that water does not reach the bottom edges of holes 11.

In summary, this disclosure shows and describes poultry feeders and waterers having a tubular main body for holding poultry feed or water. The tubular main body may include a plurality of holes formed therethrough on a first side of the tubular main body and on a second side opposite the first side. Centers of the plurality of holes may be at the same height and the plurality of holes on each side of the tubular main body may be spaced apart by a distance greater than a diameter of the plurality of holes to provide distance between birds accessing the poultry feed or water. The poultry feeders and waterers may include a stand for raising and leveling the tubular main body above the ground and a pair of internal shields within the tubular main body and extending along the length thereof that prevents the birds accessing the poultry feed or water through holes on opposite sides of the tubular main body from viewing each other.

In some embodiments, the pair of internal shields may each extend from an inner surface of the tubular main body above ones of the plurality of holes on a corresponding side of the tubular main body and downward toward a bottom of the inner surface of the tubular main body, and the pair of internal shields may terminate above a bottom of the inner surface of the tubular main body and may define a gap therebetween for passage of the poultry feed or water. The poultry feeder/waterer may include a hopper a hopper for storing poultry feed or a tank for storing water mounted above the tubular main body, wherein an inside bottom of the hopper is in communication with an interior of the tubular main body via an aperture formed through a top of the tubular main body, and wherein the pair of internal shields are sloped or curved to retain poultry feed above the pair of internal shields without filling the tubular main body with poultry feed beyond a level corresponding to bottom edges of the plurality of holes. Poultry waters having the tank may also include a pipe having an inlet in fluid communication with an inside bottom of the tank and extending downward toward the gap between the pair of internal shields and a float valve coupled to an outlet of the pipe for controlling a flow of water from the tank to the tubular main body, wherein the float valve maintains a level of water within the tubular main body below a level corresponding to bottom edges of the plurality of holes. In some embodiments, the pair of internal shields may be supported by a pair of end plugs inserted into each end of the tubular main body and having grooves on an inner face thereof for accepting a corresponding end of each of the pair of internal shields. The end plugs may be transparent so that a level of poultry feed or water within the tubular main body is observable. The poultry feeders/waterers may include a roof support structure connected to the stand and a roof attached to the roof support structure and hinged so that at least a portion of the roof can be raised to access a top of the hopper for re-filling with poultry feed or the tank for re-filling with water.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A poultry feeder/waterer, comprising:
a tubular main body for holding poultry feed or water, wherein the tubular main body includes a plurality of holes formed therethrough on a first side of the tubular main body and on a second side opposite the first side, wherein centers of the plurality of holes are at the same height and wherein the plurality of holes on each side of the tubular main body are spaced apart by a distance greater than a diameter of the plurality of holes to provide distance between birds accessing the poultry feed or water;
a stand for raising and leveling the tubular main body above the ground; and
a pair of internal shields within the tubular main body and extending along the length thereof that prevents the birds accessing the poultry feed or water through holes on opposite sides of the tubular main body from viewing each other.

2. The poultry feeder/waterer of claim 1, wherein the pair of internal shields each extend from an inner surface of the tubular main body above ones of the plurality of holes on a corresponding side of the tubular main body and downward toward a bottom of the inner surface of the tubular main body, and wherein the pair of internal shields terminate above a bottom of the inner surface of the tubular main body and define a gap therebetween for passage of the poultry feed or water.

3. The poultry feeder/waterer of claim 2, further comprising a hopper for storing poultry feed mounted above the tubular main body, wherein an inside bottom of the hopper is in communication with an interior of the tubular main body via an aperture formed through a top of the tubular main body, and wherein the pair of internal shields are sloped or curved to retain poultry feed above the pair of internal shields without filling the tubular main body with poultry feed beyond a level corresponding to bottom edges of the plurality of holes.

4. The poultry feeder/waterer of claim 3, further comprising a pair of end plugs inserted into each end of the tubular main body, wherein the pair of end plugs define grooves on an inner face thereof for accepting a corresponding end of each of the pair of internal shields, whereby the paid of end plugs support the pair of internal shields at ends of the tubular main body.

5. The poultry feeder/waterer of claim 4, wherein the pair of end plugs are formed from a transparent material, whereby a level of poultry feed within the tubular main body is observable.

6. The poultry feeder/waterer of claim 3, further comprising:
a roof support structure connected to the stand; and
a roof attached to the roof support structure and hinged so that at least a portion of the roof can be raised to access a top of the hopper for re-filling with poultry feed.

7. The poultry feeder/waterer of claim 2, further comprising:
a tank for storing water mounted above the tubular main body;
a pipe having an inlet in fluid communication with an inside bottom of the tank and extending downward toward the gap between the pair of internal shields; and
a float valve coupled to an outlet of the pipe for controlling a flow of water from the tank to the tubular main body, wherein the float valve maintains a level of water within the tubular main body below a level corresponding to bottom edges of the plurality of holes.

8. The poultry feeder/waterer of claim 7, further comprising a pair of end plugs inserted into each end of the tubular main body, wherein the pair of end plugs define grooves on an inner face thereof for accepting a corresponding end of each of the pair of internal shields, whereby the paid of end plugs support the pair of internal shields at ends of the tubular main body.

9. The poultry feeder/waterer of claim 8, wherein the pair of end plugs are formed from a transparent material, whereby a level of water within the tubular main body is observable.

10. The poultry feeder/waterer of claim 7, further comprising:
a roof support structure connected to the stand; and
a roof attached to the roof support structure and hinged so that at least a portion of the roof can be raised to access a top of the tank for re-filling with water.

11. A poultry watering device, comprising:
a tubular main body for holding water, wherein the tubular main body includes a plurality of holes formed therethrough on a first side of the tubular main body and on a second side opposite the first side, wherein centers of the plurality of holes are at the same height and wherein the plurality of holes on each side of the tubular main body are spaced apart by a distance greater than a diameter of the plurality of holes to provide distance between birds accessing the water;
a stand for raising and leveling the tubular main body above the ground; and
a pair of internal shields within the tubular main body and extending along the length thereof that prevents the birds accessing the water through holes on opposite sides of the tubular main body from viewing each other, wherein the pair of internal shields each extend from an inner surface of the tubular main body above ones of the plurality of holes on a corresponding side of the tubular main body and downward toward a bottom of the inner surface of the tubular main body, and wherein the pair of internal shields terminate above a bottom of the inner surface of the tubular main body and define a gap therebetween for passage of the poultry feed or water;
a pair of transparent end plugs inserted into each end of the tubular main body whereby a level of water within the tubular main body is observable, wherein the pair of end plugs define grooves on an inner face thereof for accepting a corresponding end of each of the pair of internal shields, whereby the paid of end plugs support the pair of internal shields at ends of the tubular main body;
a tank for storing water mounted above the tubular main body;
a pipe having an inlet in fluid communication with an inside bottom of the tank and extending downward toward the gap between the pair of internal shields;
a float valve coupled to an outlet of the pipe for controlling a flow of water from the tank to the tubular main body, wherein the float valve maintains a level of water within the tubular main body below a level corresponding to bottom edges of the plurality of holes;
a roof support structure connected to the stand; and
a roof attached to the roof support structure and hinged so that at least a portion of the roof can be raised to access a top of the hopper for re-filling with poultry feed.

12. A method of providing feed or water to poultry, the method comprising:
holding poultry feed or water within a tubular main body, wherein the tubular main body includes a plurality of holes formed therethrough on a first side of the tubular main body and on a second side opposite the first side, wherein centers of the plurality of holes are at the same height and wherein the plurality of holes on each side of the tubular main body are spaced apart by a distance greater than a diameter of the plurality of holes to provide distance between birds accessing the poultry feed or water;
supporting the tubular main body above the ground with a stand for raising and leveling the tubular main body above the ground; and
preventing the birds accessing the poultry feed or water through holes on opposite sides of the tubular main body from viewing each other with a pair of internal shields within the tubular main body and extending along the length thereof.

13. The method of claim 12, wherein the pair of internal shields each extend from an inner surface of the tubular main body above ones of the plurality of holes on a corresponding side of the tubular main body and downward toward a bottom of the inner surface of the tubular main body, and wherein the pair of internal shields terminate above a bottom of the inner surface of the tubular main body and define a gap therebetween for passage of the poultry feed or water.

14. The method of claim 13, further comprising:
storing poultry feed in a hopper mounted above the tubular main body, wherein an inside bottom of the hopper is in communication with an interior of the tubular main body via an aperture formed through a top of the tubular main body; and
preventing the filling of the tubular main body with poultry feed beyond a level corresponding to bottom edges of the plurality of holes by sloping or curving the pair of internal shields.

15. The method of claim 14, further comprising supporting the pair of internal shields at ends of the tubular main body with a pair of end plugs inserted into each end of the tubular main body, wherein the pair of end plugs define grooves on an inner face thereof for accepting a corresponding end of each of the pair of internal shields.

16. The method of claim 15, further comprising providing visibility of a level of poultry feed within the tubular main body by providing the pair of end plugs formed from a transparent material.

17. The method of claim 14, further comprising:
covering the tubular main body and the hopper with a roof support structure connected to the stand and a hinged roof supported by the roof support structure; and
raising at least a portion of the roof a roof to access a top of the hopper to re-fill the hopper with poultry feed.

18. The method of claim 13, further comprising:
storing water in a tank mounted above the tubular main body;
directing water from the tank through a pipe having an inlet in fluid communication with an inside bottom of the tank and extending downward toward the gap between the pair of internal shields; and
controlling a flow of water from the tank to the tubular main body with a float valve coupled to an outlet of the pipe to maintain a level of water within the tubular main body below a level corresponding to bottom edges of the plurality of holes.

19. The method of claim 18, further comprising:
supporting the pair of internal shields at ends of the tubular main body with a pair of end plugs inserted into each end of the tubular main body, wherein the pair of end plugs define grooves on an inner face thereof for accepting a corresponding end of each of the pair of internal shields; and
providing visibility of a level of poultry feed within the tubular main body by providing the pair of end plugs formed from a transparent material.

20. The method of claim 18, further comprising:
covering the tubular main body and the hopper with a roof support structure connected to the stand and a hinged roof supported by the roof support structure; and
raising at least a portion of the roof a roof to access a top of the tank to re-fill the tank with water.
